(19) United States
(12) Patent Application Publication
(10) Pub. No.: US 2012/0038833 A1
(43) Pub. Date: Feb. 16, 2012

(54) TELEVISION CHIP WITH A UNIQUE IDENTIFICATION AND METHOD FOR WRITING THE UNIQUE IDENTIFICATION

(75) Inventors: Xu Dong, Beijing (CN); Daniel Wong, Beijing (CN); Wei Zhao, Beijing (CN); Qifeng Liu, Beijing (CN)

(73) Assignee: Powerplayer Microsystems Holding Inc., George Town, KY (US)

(21) Appl. No.: 13/059,928

(22) PCT Filed: Aug. 21, 2009
(86) PCT No.: PCT/CN2009/073409

§ 371 Date: May 10, 2011

(30) Foreign Application Priority Data
Aug. 21, 2008 (CN) 2008101471603

(51) Int. Cl. H04N 5/44

(52) U.S. Cl. 348/725; 348/E05.096

(57) ABSTRACT

In order that a television connected to a network can be uniquely identified, a television chip with a unique identification is provided. A non-volatile storage unit is set in the television chip, and the unique identification that can be uniquely identified in a determined scope is stored in the storage unit. After the unique identification is written in the storage unit, the storage unit is set up as a read-only storage unit; and the television chip is set in a television that can be connected to the network. The technical scheme of the invention can be applied to the television decoding chip in the television, wherein the television is connected to the network, a specific television can be identified through the network, so that it will be easier and more accurate during billing the consumption of users owning the television.

### TECHNICAL FIELD

This invention refers to a technology of chip identification.

### TECHNICAL BACKGROUND

With development of electronic technology and Internet technology, connecting TV set to the Internet is a developing trend, the TV set can capture more abundant program resources via the Internet, and there is more freedom for audience to select time to enjoy program.

The TV set connected to the Internet shall and can be accurately recognized on the Internet. It has actually significance, for example, person can enjoy various charging programs or buy something on the web via a TV set connected to the Internet, if this TV set can be recognized on the Internet, and this TV set can be more easily and more accurately charged. But, currently, there is no technical scheme for recognizing TV set on the Internet. Current methods for recognizing TV set via identifications are all using patterns or characters adhered on outside of TV sets, which are only offered for artificially recognizing TV set, but cannot recognize a special TV set via the Internet.

### DETAILED DESCRIPTIONS OF THIS INVENTION

For unique-recognizing TV set connected to the Internet, this invention offers a TV chip with a unique identification that can be unique-recognized on the Internet, therefore, to recognize this TV set.

Other purpose of this invention is to offer a method for writing the unique identification into the chip.

### Technical Scheme of this Invention is as Follows

For a TV chip with a unique identification, a nonvolatile memory device is built in the TV chip, the said unique identification able to be unique-recognized within a given range is stored into the said memory device, after the said unique identification is written into the said memory device, the said memory device is set as a ROM, that is, the memory device stored with the said unique identification is a ROM; the said TV chip is built into a TV set that can be connected to the Internet.

The said TV chip is a digital TV decoding chip.

The said memory device is EPROM (erasable nonvolatile memory device) or OTP (one-time program memory device) or electrical fuse memory device.

The said unique identification is a number set with complex digits, in which numbers at some digits represent position information of the TV chip on wafer, or other information related with production of the TV chip, for example, information of chip manufacturer, LOT number and wafer number for producing the chip.

The method for writing the unique identification into TV chip includes step as follows: at wafer test phase, test equipment writes the unique identification into the memory device of the TV chip. The test equipment adopts known position information of the tested TV chip on wafer as numbers at some digits for the unique identification to form the said unique identification; at phase of encapsulating the TV chip after writing the unique identification in, the writing channel of the memory device is encapsulated in the encapsulated body.

Another method for writing the unique identification into TV chip includes step as follows: at final test phase after encapsulating the TV chip, the test equipment writes the unique identification into the memory device of the TV chip. Test equipment adopts unique sequence number as some digit's numbers in unique identification to form the said unique identification.

### TECHNICAL EFFECTS OF THIS INVENTION

Because the unique identification able to be unique-recognized is built into TV chip, during the TV chip is in application (or in power supply), this TV chip can be recognized via reading the unique identification built in the TV chip; if the TV chip is built in TV set, the TV set with such TV chip can be unique-recognized on the Internet. If this kind of TV set is connected into the Internet, this special TV set can be recognized via the Internet, it will be easier and more accurate for recording consumer fees of the person who uses this TV set. The nonvolatile memory device adopted assures not to lose the unique identification stored in the memory device of the chip when power supply is interrupted. After the unique identification is written into the memory device, the memory device becomes a ROM, that is, the unique identification within the memory device can be read, but cannot be rewritten, which can guarantee that the unique identification cannot be falsified at will, in order to guarantee that the TV chip is unique-recognized.

This invention selects to write the unique identification into the memory device within the TV chip at test phase in manufacturing process of the TV chip, substantially at the wafer test phase or at the final test phase after encapsulating the TV chip. Test equipment at the above test phases can test each TV chip or encapsulated TV chip, the software program can be modified to make the test equipment being able to write data (that is, the identification) into the memory device of the TV chip, in this way, it is possible to change whole production process of the TV chip less with lower cost.

### EXPLANATION FOR ATTACHED DRAWING

FIG. 1 is a structure diagram of the digital TV decoding chip adopting technical scheme of this invention.

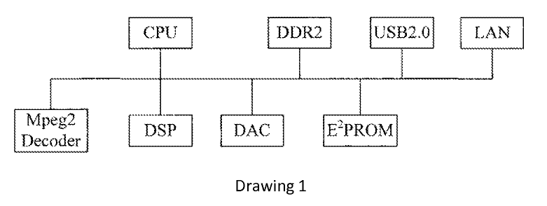

### EMBODIMENT

The technical scheme of this invention is explained in details in this section.

In this invention, nonvolatile memory device is built into TV chip and a unique identification (generally, a series of numbers with several digits, hereinafter called as a unique identification code, or a unique identification information, all are the same concept) is written into the memory device. The nonvolatile memory device assures that the information stored in the memory device will not be lost in the case of power supply disconnected, therefore, even if power supply to the TV chip is turned off, the unique identification will not be lost. When the TV chip is in operation status or under power supply, this TV chip can be unique-recognized via reading the unique identification within the memory device, it also means to that TV set built-in with this TV chip can be recognized. It is very useful when the TV set is connected on the Internet because operation of the TV set can be monitored accurately. When the unique identification is written into the memory device, the memory device is in RO (read only) status, which can guarantee that the unique identification cannot be falsified at will, the TV chip can be unique-recognized, especially when the unique identification is used as a basis for charging fees, it is more important to avoid any charging confusion usually caused by changed identification. After writing the unique identification, there are many ways to make it into RO status, for example, during encapsulating the chip, its writing channel of the memory device is also encapsulate in its encapsulated body; or a memory device only permitting one-time writing is adopted, for example, OTP and etc; or operation of writing memory device in the TV chip is prohibited via setting software.

In this invention, the memory device mentioned above can be arranged in the digital TV decoding chip of TV set, mainly because the digital TV decoding chip is a necessary chip for each TV set, and it is convenient for all of TV sets to be built-in with a unique identification. The nonvolatile memory device, i.e. a kind of memory devices written in with a unique identification, is adopted as a memory device, thus the unique identification information will not be lost when power supply of the TV chip is turned off. Generally, such memory devices include EPROM or OTP (one-time programmable memory device) or electrical fuse memory device). Drawing 1 is an example of this invention, in which, besides devices commonly adopted in digital TV decoding chip, such as CPU, Mpeg2Decoder and etc., a memory device is also built-in. In this drawing, E²PROM (Electrically Erasable Programmable Read-Only Memory) is adopted and a unique identification code is written in via high-voltage pins under high-voltage function.

The unique identification shall be unique-recognized within a given range, the given range said here refers to TV chips produced according to the same compilation rule of the unique identification; if one compilation rule is adopted as an international standard, such TV chip can be recognized within a larger area, such as in world scope, the TV sets connected on the Internet can also be recognized.

The following table gives an example to explain the compilation rule of the unique identification and the storage. Length of the unique identification code is an eight bit data (64 digit binary), its position in data frame is that low address bit locates in front; all of the data is hexadecimal coding, except special definition.

| Definition | Address | Explanation |
|---|---|---|
| Reservation bit | SN[7:0] | 8-bit, reserved as |
| | | expandable bits |
| Manufacturer code | SN[15:8] | 8-bit |
| Year | SN[22:16] | 7-bit, only the last 2 bits in |
| | | International Year is |
| | | recorded |
| Month | SN[26:23] | 4-bit |
| Day | SN[31:27] | 5-bit |
| LOT number | SN[42:32] | 11-bit |
| Wafer number | SN[47:43] | 5-bit |
| TV chip's X coordinate on wafer | SN[55:48] | 8-bit |
| TV chip's Y coordinate on wafer | SN[63:56] | 8-bit |

For example, a TV chip manufacturer (code: 00000001) produces one of TV chip in LOT number 123 and on No. 15 wafer on Dec. 30, 2003, and its coordinate of this TV chip on the wafer is (23, 21), the code for this TV chip is as follows:

| | | | | | | | |
|---|---|---|---|---|---|---|---|
| 00 | 01 | 07 | 9E | 0F | 6F | 17 | 15 |

Each grid of the above code corresponds to the definitions in the table above sequentially, of which 6F refers to two definitions of LOT number and wafer number., the data in each grid is represented as hexadecimal, and transferred to binary data as follows:

SN[0:63]

Binary format (divided according to represented significance) 00000000, 00000001, 0000011, 1100, 11110, 00001111011, 01111, 00010111, 00010101

Binary format (divided according to each 4 digits)

0000, 0000, 0000, 0001, 0000, 0111, 1001, 1110, 0000, 1111, 0110, 1111, 0001, 0111, 0001, 0101

Hexadecimal format 00-01-07-9E-0F-6F-17-15

There is no obvious difference between the process for manufacturing the TV chip with a unique identification mentioned in this invention and a common process for producing a TV chip, of which all have steps of wafer processing—wafer testing—encapsulating—final testing. The only difference is to write the unique identification code into the TV chip by using test equipment in the process of wafer testing or final testing. Process for writing the unique identification at the steps of wafer testing and final testing are respectively explained below, but it is necessary to point out that the TV chip mentioned in following process is the one built-in with nonvolatile memory device. The method below mainly concerns how to write a unique identification into a memory device.

1. Writing at wafer test phase

The main equipment used at wafer test phase is automatic test equipment (ATE), and some auxiliary equipment such as probe, robots and etc. During testing wafer, the probe will transmit LOT number and wafer number to ATE, and before testing each TV chip, it will also transmit coordinates of a pending chip to the test equipment, after reading these information the test equipment forms a unique identification for the chip according to a rule, for example, transferring information obtained above into numbers for some digits in the unique identification, and writes the unique identification code into relative position within the memory device of the TV chip. After completing this step, the probe moves to the position for testing next pending TV chip. The processes mentioned above are repeated to make memory device of each TV chip have its own unique identification code.

It is necessary to point out that original point (0, 0) of TV chip on wafer is positioned at upper right corner; therefore coordinates at left side of the original point are potentially negative numbers. Because the stored date exists in binary form, highest digit in binary numbers can be adopted to express positive and negative.

In order to avoid written-in unique identification code within memory device of TV chip from interpolation, necessary measure shall be adopted to realize this purpose. Following schemes are performed in this invention for this purpose: OTP utilized as a memory device is just a technology to prevent interpolation after one-time writing; after writing a unique identification code into memory device, at its following process for encapsulating TV chip, writing channel of the memory device is encapsulated in the sealed body, that is, there are no any writing pins existed among pins outside of the sealed body, thus to realize the purpose mentioned above.

2. Writing at final test phase

Final test is performed after encapsulating the TV chip, which can also write a unique identification code into memory device of TV chip via test equipment. It needs writing-in pins on memory device, which shall be prepared in process of encapsulating TV chip, and simultaneously, for avoiding any interpolation on written-in unique identification code, OTP is adopted as a technology, which cannot be falsified once a unique identification code is written-in, and it can also be realized via setting software embed within TV chip to prohibit any information from re-writing into the memory device after finishing process of writing the unique identification.

In addition, the TV chip has been separated from wafer at this phase, and there is no way to obtain information related to the wafer, but a unique identification code can be formed via adopting following method: sequence numbers can be used to substitute for digit numbers that represent wafer information (LOT number, wafer number, coordinates of TV chip on wafer) in the unique identification code at wafer test phase, for example, beginning counting from 1, and once completing each process to write-in a unique identification into a TV chip on the test equipment, the number on the relative digit shall add 1 for the next TV chip.

1. A TV chip with unique identification, comprising:
a nonvolatile memory device built in the TV chip, wherein the unique identification can be uniquely identified within a given range stored into the said memory device, after the unique identification is written into the memory device, wherein:
the memory device is set as a ROM; and
the TV chip is set into a TV set that can be connected to the Internet.

2. A TV chip with unique identification, as in claim 1, wherein said TV chip is a digital TV decoding chip.

3. A TV chip with unique identification, as in claim 1, wherein said memory device is an EPROM, or OTP, or electrical fuse memory device.

4. A TV chip with unique identification, as in claim 1, wherein said unique identification comprises numbers with complex digits, in which numbers at some digits represent position information of the TV chip on wafer.

5. A method for writing the unique identification into the TV chip of claim 1, comprising, at a wafer test phase, test equipment writing the unique identification into the memory device of the TV chip.

6. A method for writing the unique identification as in claim 5, wherein the test equipment adopts known position information of the tested TV chip on wafer as some digit's numbers for the unique identification to form the unique identification.

7. A method for writing the unique identification as in claim 5, further comprising at a phase of encapsulating the TV chip after writing the unique identification, encapsulating the writing channel of the memory device in the encapsulated body.

8. A method for writing the unique identification into the TV chip of claim 1, comprising at a phase of testing the finished product after encapsulating the TV chip, test equipment writing the unique identification into the memory device of the TV chip.

9. A method for writing the unique identification as in claim 8, further comprising the test equipment adopting a unique sequence number as some digit's numbers in unique identification to form the said unique identification.

10. A TV chip with unique identification, as in claim 2, wherein said memory device is an EPROM, or OTP, or electrical fuse memory device.

11. A TV chip with unique identification, as in claim 2, wherein said unique identification comprises numbers with complex digits, in which numbers at some digits represent position information of the TV chip on wafer.

12. A method for writing the unique identification as in claim 5, wherein said TV chip is a digital TV decoding chip.

13. A method for writing the unique identification as in claim 5, wherein said memory device is an EPROM, or OTP, or electrical fuse memory device.

14. A method for writing the unique identification as in claim 5, wherein said unique identification comprises numbers with complex digits, in which numbers at some digits represent position information of the TV chip on wafer.

15. A method for writing the unique identification as in claim 8, wherein said TV chip is a digital TV decoding chip.

16. A method for writing the unique identification as in claim 8, wherein said memory device is an EPROM, or OTP, or electrical fuse memory device.

17. A method for writing the unique identification as in claim 8, wherein said unique identification comprises numbers with complex digits, in which numbers at some digits represent position information of the TV chip on wafer.
